(19) United States
(12) Patent Application Publication
(10) Pub. No.: US 2025/0301942 A1
(43) Pub. Date: Oct. 2, 2025

(54) Spreader for Spreading Spreadable Material and Spreading Chute

(71) Applicant: Amazonen-Werke H. Dreyer SE & Co. KG, Hasbergen (DE)

(72) Inventors: Herbert BÄUMKER, Hilter (DE); Jan ESSLAGE, Münster (DE)

(73) Assignee: Amazonen-Werke H. Dreyer SE & Co. KG, Hasbergen (DE)

(21) Appl. No.: 18/865,292

(22) PCT Filed: May 2, 2023
(86) PCT No.: PCT/EP2023/061467

§ 371 Date: Nov. 12, 2024

(30) Foreign Application Priority Data
May 13, 2022 (DE) 10 2022 112 026.0

(51) Int. Cl. A01C 15/12; A01C 17/00; E01C 19/20

(52) U.S. Cl. CPC A01C 15/122; A01C 17/008; E01C 19/203; E01C 2019/207

(57) ABSTRACT

A chute for spreadable material for guiding spreadable material in the direction of a spreading disk of a spreader, having several guide surfaces which extend from a supply region for the spreadable material in the direction of the spreading disk.

### CROSS REFERENCE TO RELATED APPLICATIONS

The present application claims priority under 35 U.S.C. § 365 to PCT/EP2023/061467 filed on May 2, 2023 and under 35 U.S.C. § 119(a) to German Application No. 10 2022 111 026.0 filed on May 13, 2022, both of which are incorporate by reference in their entireties.

### BACKGROUND

The disclosure relates to a chute for spreadable material, a supply system for spreadable material, and a spreader for spreading spreadable material.

Chutes for spreadable material for guiding spreadable material in the direction of a spreading disk are used, for example, in spreaders in which the spreadable material is conveyed via a belt base or other conveying device from a storage container in the direction of spreading disks. In known chutes for spreadable material, the point of impact of the spreadable material onto the spreading disk depends to a large extent on the current amount of spreadable material being supplied. With small supply quantities, the point of supply of the spreadable material onto the spreading disk differs from the point of impact for large supply quantities. A change in the supply quantity therefore leads to a change in the distribution of the spreadable material. Small supply quantities in particular have previously led to a strong deviation in the impact region and thus to a significant change in the spreading pattern.

With some chutes for spreadable material, clogging also forms along the conveying path when large quantities are supplied, in particular when a transverse plate is used to separate the quantities.

### SUMMARY

The object underlying the disclosure is therefore to be able to ensure an intended spreadable material distribution even with a varying quantity of spreadable material supplied, where clogging or other blockages along the chute for spreadable material are to be prevented.

The object is satisfied by a chute for spreadable material of the kind mentioned at the outset, where the chute for spreadable material according to the disclosure comprises a separating body which separates a first path for spreadable material from a second path for spreadable material so that the spreadable material supplied onto at least one of the guide surfaces in the supply region is divided at least temporarily during the motion in the direction of the spreading disk into a first partial flow of spreadable material which moves along the first path for spreadable material, and a second partial flow of spreadable material which is separated from the first partial flow of spreadable material by the separating body and moves along the second path for spreadable material.

By dividing the supplied spreadable material into two partial flows of spreadable material, different amounts of spreadable material can be precisely supplied onto a spreading disk so that an intended spreading pattern can be obtained substantially independent of the quantity. Furthermore, the tendency for clogging is significantly reduced by dividing the spreadable material into two partial flows of spreadable material.

The first path for spreadable material and the second path for spreadable material can have different lengths so that different sliding distances arise along the chute for spreadable material. The spreadable material supplied onto the chute for spreadable material in a first partial section of the supply region preferably moves along the first path for spreadable material. The spreadable material supplied onto the chute for spreadable material in a second partial section of the supply region preferably moves along the second path for spreadable material. A partial section of the supply region is disposed further laterally outwardly in relation to the spreader than another partial section of the supply region. This results in an outer partial section of the supply region and an inner partial section of the supply region.

One of the partial flows of spreadable material can be larger than the other. In particular, the mass flow, for example in kg/s, of one partial flow of spreadable material is greater than the mass flow of the other partial flow of spreadable material. One partial flow of spreadable material can be a main flow of spreadable material and the other partial flow of spreadable material can be a secondary flow of spreadable material.

The spreadable material can be grainy or granular material. The spreadable material can be fertilizer. The fertilizer can comprise fertilizer grains.

In a preferred embodiment of the chute for spreadable material according to the disclosure, the separating body is arranged such that the first partial flow of spreadable material and the second partial flow of spreadable material delimited from the first partial flow of spreadable material arise independently of the amount of spreadable material supplied onto the supply region. It is therefore not necessary for a spreadable material spillover to occur in a spillover region of the chute for spreadable material in order to create two partial flows of spreadable material delimited from one another. The two partial flows of spreadable material therefore arise independently of the amount supplied.

In a further preferred embodiment of the chute for spreadable material according to the disclosure, the separating body is configured as a separating web, where the separating web preferably stands upright on a guide surface. The separating web can have one or more bends over which the spreadable material flowing along the separating web is guided. Alternatively or additionally, the separating web can be configured in the shape of an arc and/or a circular segment, where a longitudinal direction of the separating web preferably runs at least substantially in correspondence and/or parallel to the paths for spreadable material. The separating web is particularly preferably arranged such that one of the partial flows of spreadable material is conveyed along the inner side of the separating web and the other partial flow of spreadable material is conveyed along the outer side of the separating web. The separating web can be rounded at the front or have a separating tip so that no foreign bodies, for example clods, and no spreadable material gets caught on the front side of the separating web.

In a further development of the chute for spreadable material according to the disclosure, one or more guide surfaces form a chute ramp, where the first path for spreadable material or the second path for spreadable material run over the chute ramp. Preferably, the respective other path for spreadable material does not run over the chute ramp. The one or more guide surfaces of the chute ramp run at a higher level in comparison to other guide surfaces that run beyond the chute ramp. The chute ramp ensures that partial flows of spreadable material are conveyed along different height levels within the chute for spreadable material.

In addition, a chute for spreadable material according to the disclosure with a spillover saddle is advantageous, which is arranged in a spillover region at or on a guide surface and provides a spillover path for the spreadable material. A spillover flow of spreadable material that forms from the first or second partial flow of spreadable material can be guided onto the spillover path in the direction of the spreading disk. If a flow spillover height is exceeded, a spillover occurs at the spillover saddle. The spreadable material moving below the flow spillover height does not reach the spillover path of the spillover saddle. The spreadable material moving above the flow spillover height reaches the spillover path of the spillover saddle. In the event of large quantities of spreadable material, the spillover saddle therefore ensures that a further partial flow of spreadable material, namely the spillover flow, is branched off.

In a further development of the chute for spreadable material according to the disclosure, the spillover saddle is disposed on the chute ramp. The spillover saddle therefore enables the flow of spreadable material along a further height level along the chute for spreadable material. A partial flow of spreadable material there flows beyond the chute ramp and two partial flows of spreadable material flow over the chute ramp, where a spillover flow flows over the spillover saddle on the chute ramp.

A chute for spreadable material according to the disclosure is furthermore advantageous in which the guide surfaces are configured to guide the spreadable material to a chute opening of the chute for spreadable material via which the spreadable material leaves the chute for spreadable material in the direction of the spreading disk, where the region where the spreadable material is supplied to the chute for spreadable material is preferably disposed on a first side of the chute opening and at least one circulation path of the spreadable material leads to a guide surface which is disposed on a second side of the chute opening. Preferably, the second side of the chute opening is arranged opposite the first side of the chute opening. Preferably, the first side of the chute opening in relation to the direction of travel is the front side. Preferably, the first side of the chute opening faces the conveying device. Preferably, the second side of the chute opening in relation to the direction of travel is the rear side. Preferably, the second side of the chute opening faces away from the conveying device.

The chute for spreadable material according to the disclosure is furthermore advantageously further developed in that the circulation path is part of the spillover path or the spillover path merges into the circulation path. When there are large quantities of spreadable material, the spreadable material spills over at the spillover saddle and then reaches the circulation path. When there are small quantities of spreadable material, there is no spreadable material spillover at the spillover saddle so that no spreadable material reaches the circulation path.

In another preferred embodiment, the chute for spreadable material comprises a contact bevel which is configured to prevent spreadable material supplied onto the chute for spreadable material from dropping through the chute opening without contact with a guide surface. Directly supplying spreadable material onto the spreading disk without contact with the chute is thus prevented. In this manner, it can be ensured that the entire amount of spreadable material discharged in the direction of the chute for spreadable material is guided over the guide surfaces of the chute for spreadable material in the intended manner.

In another preferred embodiment of the chute for spreadable material according to the disclosure, one or more guide elements are arranged on at least one of the guide surfaces and are configured to deflect the spreadable material flowing along the guide surface. The guide elements can be elevations in the guide surface. The guide elements are preferably elongated. The guide elements can be guide webs or guide rods. The guide elements are preferably arranged in the supply region or in the immediate vicinity of the supply region. The guide elements preferably have a height and/or a geometry which allow for the spillover of the spreadable material. The guide elements can alternatively or additionally also be, for example, vertical or perpendicular walls of at least one spreadable material channel embossed or molded into a guide surface.

Beyond that, a chute for spreadable material according to the disclosure is preferred in which the guide elements extend along a longitudinal axis and the longitudinal axes extend substantially in the direction of the path for spreadable material leading to the chute ramp. Preferably, several guide elements run parallel to one another. Alternatively or additionally, guide elements can also run at an angle to one another. The guide elements preferably redirect the spreadable material in the direction of the chute ramp.

The object underlying the disclosure is also satisfied by a supply system of the kind mentioned at the outset, where the chute for spreadable material of the supply system according to the disclosure is configured according to one of the embodiments described above. With regard to the advantages and modifications of the supply system according to the disclosure, reference is first made to the advantages and modifications of the chute for spreadable material according to the disclosure.

The actuator preferably comprises a downwardly inclined discharge surface with a discharge edge, where the spreadable material leaving the discharge surface via the discharge edge drops onto the spreading disk. By moving the actuator, the orientation and/or position of the discharge surface and its discharge edge can be changed relative to the spreading disk so that the point of discharge and/or the direction of discharge of the spreadable material in the direction of the spreading disk and therefore also the point of impact of the spreadable material onto the spreading disk is adjustable by moving the actuator. The spreading pattern can therefore be changed by moving the actuator.

In a preferred embodiment of the supply system according to the disclosure, the actuator is configured as a rotatable and/or slideable funnel tip. The funnel tip can be slideable parallel and/or transverse to a direction of travel of the spreader. The funnel tip can be configured to be translationally slideable and/or rotatable relative to the spreading disk and/or to the chute for spreadable material. By rotating the funnel tip, the orientation and position of the discharge surface and its discharge edge are changed so that a change in the point of impact of the spreadable material onto the spreading disk arises. By sliding the funnel tip, the position of the discharge surface and its discharge edge are changed so that a change in the point of impact of the spreadable material onto the spreading disk arises.

The object underlying the disclosure is furthermore satisfied by a spreader of the kind mentioned at the outset, where the chute for spreadable material of the spreader according to the disclosure is configured according to one of the embodiments described above or is part of a supply system according to one of the embodiments described above. With regard to the advantages and modifications of the spreader according to the disclosure, reference is made to the advantages and modifications of the chute for spreadable material according to the disclosure and the advantages and modifications of the supply system according to the disclosure. The conveying device of the spreader can be, for example, a conveyor belt.

### BRIEF DESCRIPTION OF THE DRAWINGS

Preferred embodiments of the disclosure shall be explained and described in more detail below with reference to the accompanying drawings, where:

FIG. 1 shows a dispensing system according to the disclosure with two chutes for spreadable material at the beginning of a supply of spreadable material in a schematic illustration;

FIG. 2 shows the chutes for spreadable material of the supply system depicted in FIG. 1 during a supply of spreadable material that has already been ongoing for a longer period of time;

FIG. 3 shows paths for spreadable material along a chute for spreadable material according to the disclosure during the supply of a comparatively large amount of spreadable material;

FIG. 4 shows the development of flows of spreadable material along a chute for spreadable material according to the disclosure at the beginning of the supply of a comparatively large amount of spreadable material in a schematic view from behind;

FIG. 5 shows the supply situation depicted in FIG. 4 in a schematic top view;

FIG. 6 shows a division of the flows of spreadable material following the supply situation depicted in FIG. 4 in a schematic view from behind;

FIG. 7 shows the supply situation depicted in FIG. 6 in a schematic top view;

FIG. 8 shows a division of the flows of spreadable material following the supply situation depicted in FIG. 6 in a schematic view from behind;

FIG. 9 shows the supply situation depicted in FIG. 8 in a schematic top view;

FIG. 10 shows paths for spreadable material along a chute for spreadable material according to the disclosure during the supply of a comparatively small amount of spreadable material;

FIG. 11 shows the development of flows of spreadable material along a chute for spreadable material according to the disclosure at the beginning of the supply of a comparatively small amount of spreadable material in a schematic top view;

FIG. 12 shows a division of the flows of spreadable material following the supply situation depicted in FIG. 11 in a schematic top view;

FIG. 13 shows a division of the flows of spreadable material following the supply situation depicted in FIG. 12 in a top view;

FIG. 14 shows a path for spreadable material through an actuator in a first operating position of the actuator;

FIG. 15 shows a path for spreadable material through the actuator depicted in FIG. 14 in a second operating position of the actuator; and

FIG. 16 shows a path for spreadable material through the actuator depicted in FIG. 14 in a third operating position of the actuator.

### DETAILED DESCRIPTION

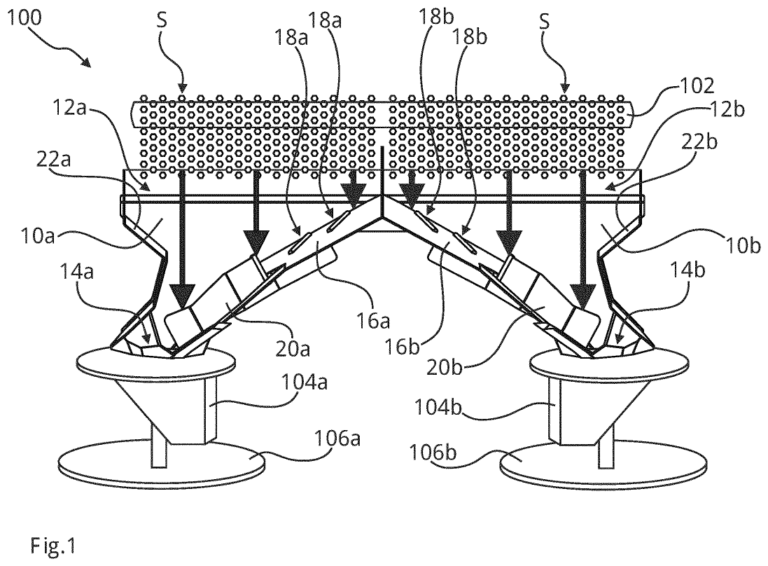

FIG. 1 shows a supply system 100 for spreadable material S. Supply system 100 is part of a spreader configured as a fertilizer spreader by way of which spreadable material S, presently fertilizer, can be spread onto agricultural arable land.

Supply system 100 comprises a conveying device 102 by way of which spreadable material S can be supplied from a storage container of the spreader onto two chutes 10a, 10b for spreadable material. Conveying device 102 is a belt base, therefore comprises a driven conveyor belt.

Chutes 10a, 10b for spreadable material are arranged side by side, where chute 10a for spreadable material is arranged on the left-hand side and chute 10b for spreadable material on the right-hand side.

Spreadable material S conveyed by way of conveying device 102 drops into chutes 10a, 10b for spreadable material in the region of a belt deflection due to gravity. Spreadable material S drops into supply regions 12a, 12b of chutes 10a, 10b for spreadable material. Spreadable material S supplied onto chutes 10a, 10b for spreadable material leaves chutes 10a, 10b for spreadable material via chute openings 14a, 14b in the direction of spreading disks 106a, 106b of the spreader.

Arranged below chutes 10a, 10b for spreadable material are actuators 104a, 104bof supply system 100 that are movable relative to the chutes for spreadable material, where the point of discharge and the direction of discharge of spreadable material S in the direction of spreading disks 106a, 106b are adjustable with a motion of actuators 104a, 104b. Actuators 104a, 104b are configured as movable funnel tips, where the impact region of spreadable material S onto spreading disks 106a, 106b is adjustable by way of a rotary motion of actuators 104a, 104b configured as funnel tips so that the spreading pattern changes.

Spreadable material S guided over chute 10a for spreadable material drops onto spreading disk 106a. Spreadable material S guided over chute 10b for spreadable material drops onto spreading disk 106b. Spreading disks 106a, 106b are rotationally driven and throw supplied spreadable material S toward the rear for being spread onto agricultural arable land.

Chutes 10a, 10b for spreadable material comprise several guide surfaces 16a, 16b, which extend from respective supply region 12a, 12b for spreadable material S in the direction of chute openings 14a, 14b.

Chutes 10a, 10b for spreadable material each comprise two guide elements 18a, 18b running parallel to one another which are configured to deflect spreadable material S that is supplied onto chutes 10a, 10b for spreadable material and that flows along guide surfaces 16a, 16b. Guide elements 18a, 18b are elongated guide webs which are arranged in the immediate vicinity of supply regions 12a, 12b.

Chutes 10a, 10b for spreadable material furthermore each comprise a separating body 20a, 20b, where separating bodies 20a, 20b are configured to divide spreadable material S supplied onto chutes 10a, 10b for spreadable material into two partial flows TS1, TS2 of spreadable material. Separating bodies 20a, 20b are arranged such that two partial flows TS1, TS2 of spreadable material arise independently of the amount of spreadable material supplied onto respective supply region 12a, 12b. Separating bodies 20a, 20b are configured as separating webs which stand upright on guide surfaces 16a, 16b. Separating bodies 20a, 20b configured as separating webs have several bends over which spreadable material S flowing along the separating web is guided.

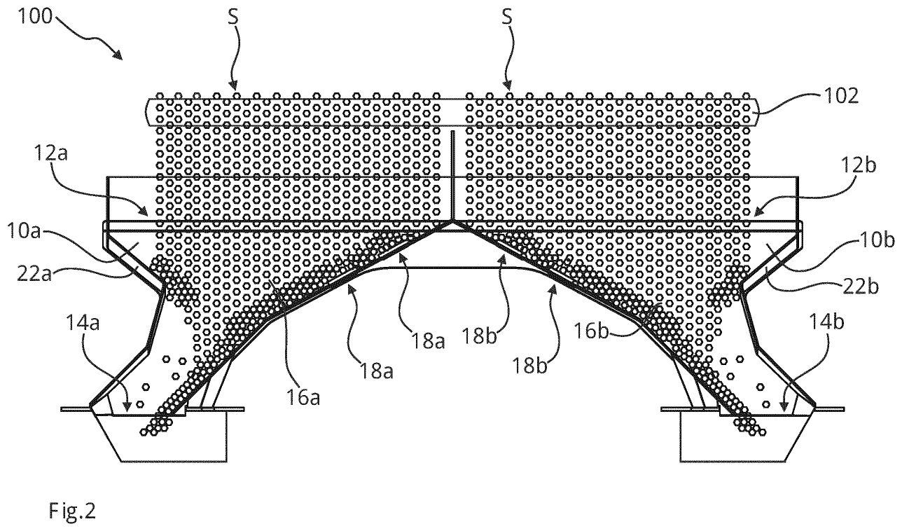

FIG. 2 shows that guide elements 18a, 18b each have a height and geometry which allow spreadable material S to flow over.

Chutes 10a, 10b for spreadable material also comprise lateral contact bevels 22a, 22b which prevent spreadable material S supplied onto respective chute for 10a, 10b for spreadable material from dropping through respective chute opening 14a, 14b without contact with a guide surface 16a, 16b. Direct supply of spreadable material onto spreading disks 16a, 16b without contact with the chute is thus prevented.

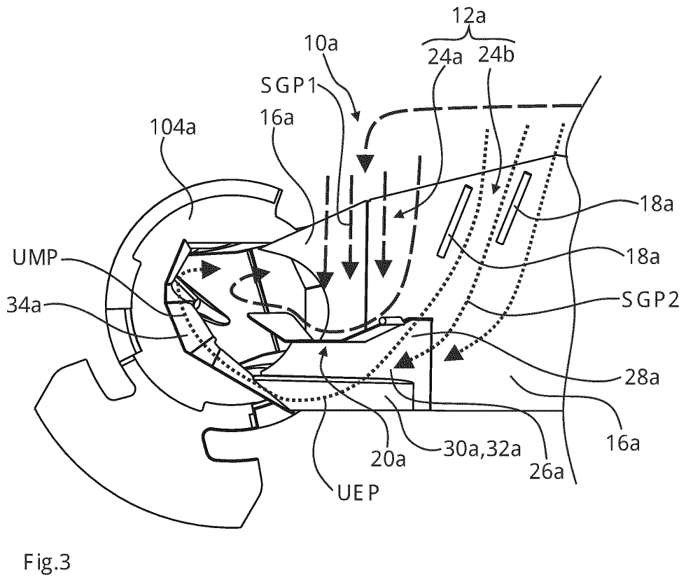

FIG. 3 shows resulting paths SGP1, SGP2, UEP, UMP for spreadable material on chute 10a for spreadable material when a comparatively large amount of spreadable material S is supplied.

Spreadable material S is supplied in a supply region 12a onto chute 10a for spreadable material. Supply region 12a comprises two partial sections 24a, 24b. Spreadable material S supplied into first partial section 24a of supply region 12a onto chute 10a for spreadable material moves along first path SGP1 for spreadable material. Spreadable material S supplied into second partial section 24b of supply region 12a onto chute 10a for spreadable material moves along second path SGP2 for spreadable material. Separating body 20a separates first path SGP1 for spreadable material from second path SGP2 for spreadable material so that spreadable material S supplied onto guide surfaces 16a in supply region 12a temporarily divides into a first flow TS1 of spreadable material which moves along first path SGP1 for spreadable material, and into a second partial flow TS2 of spreadable material which is delimited from first partial flow TS1 of spreadable material by separating body 20a and moves along second path SGP2 for spreadable material.

Guide surfaces 28a, 32a of chute 10a for spreadable material form a chute ramp 26a. Second path SGP2 for spreadable material runs over chute ramp 26a. Guide surface 28a of chute ramp 26a runs elevated in comparison to other guide surfaces 16a of chute 10a for spreadable material which run beyond chute ramp 26a. Partial flow TS2 of spreadable material is guided by way of chute ramp 26a in sections along a higher level than partial flow TS1 of spreadable material.

Disposed on chute ramp 26a is a spillover saddle 30a which is arranged in a spillover region at guide surface 28a and provides a spillover path UEP for spreadable material S on which a spillover flow US for spreadable material S forming from second partial flow TS2 of spreadable material can be guided in the direction of spreading disk 106a.

Spreadable material S flowing over the spillover saddle reaches a circulation path UMP which leads to guide surface 34a. Guide surface 34a is arranged on the side of chute opening 14a opposite supply region 12a.

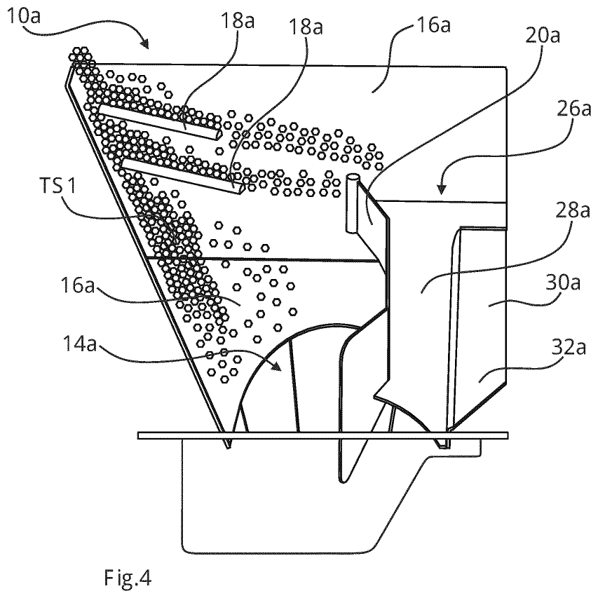

FIGS. 4 to 9 show the formation of partial flows TS1, TS2, US of spreadable material when a comparatively large amount of spreadable material is supplied onto chute 10a for spreadable material.

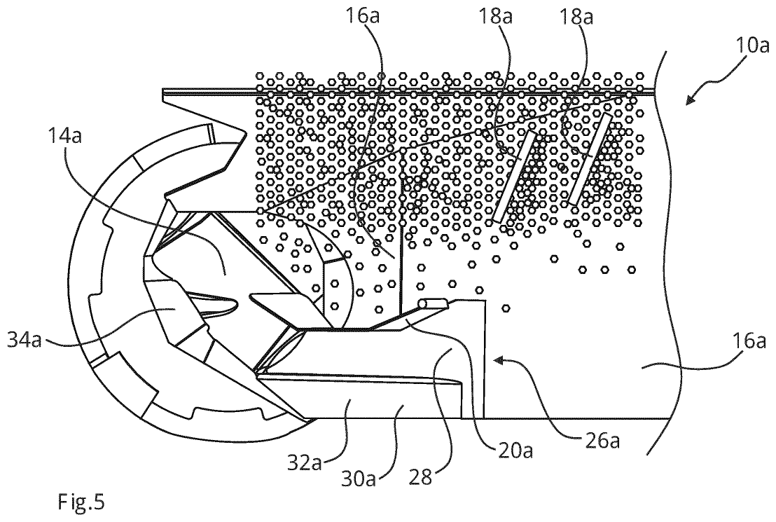

FIGS. 4 and 5 show a state that arises at the beginning of the supply of a comparatively large amount of spreadable material onto chute 10a for spreadable material. Spreadable material S supplied onto guide surface 16a is deflected in part by guide elements 18a in the direction of chute ramp 26a. The non-deflected portion of spreadable material S forms a first partial flow TS1 of spreadable material immediately at the beginning of the supply of spreadable material.

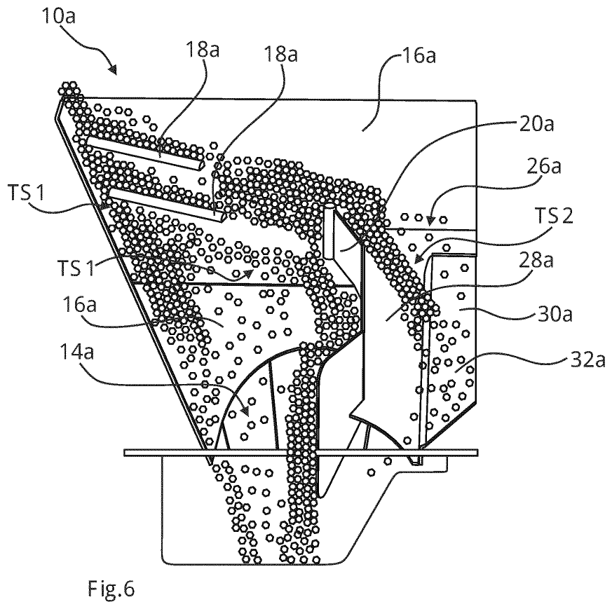

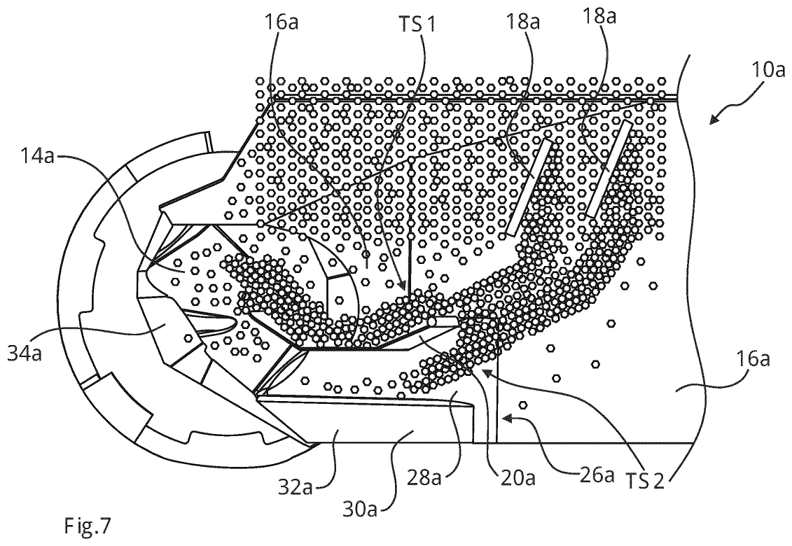

FIGS. 6 and 7 show that spreadable material S deflected by guide elements 18a reaches chute ramp 26a in part and forms a second partial flow TS2 of spreadable material. Partial flows TS1, TS2 of spreadable material are delimited from one another by separating body 20a that is configured as a separating web.

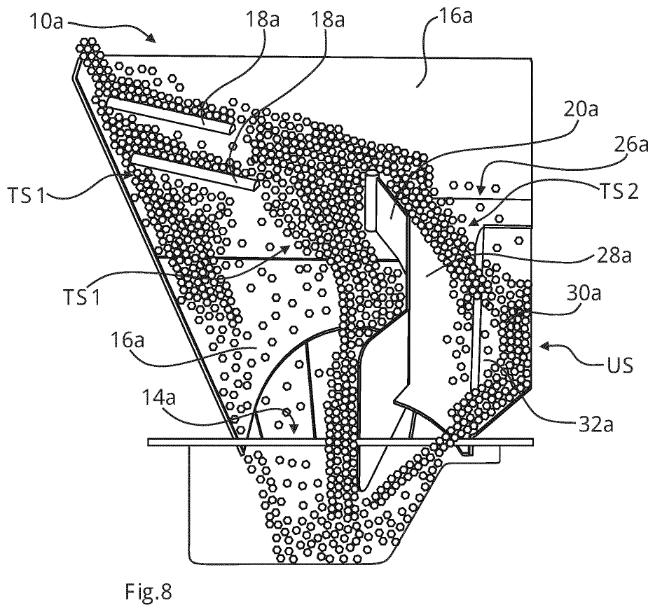

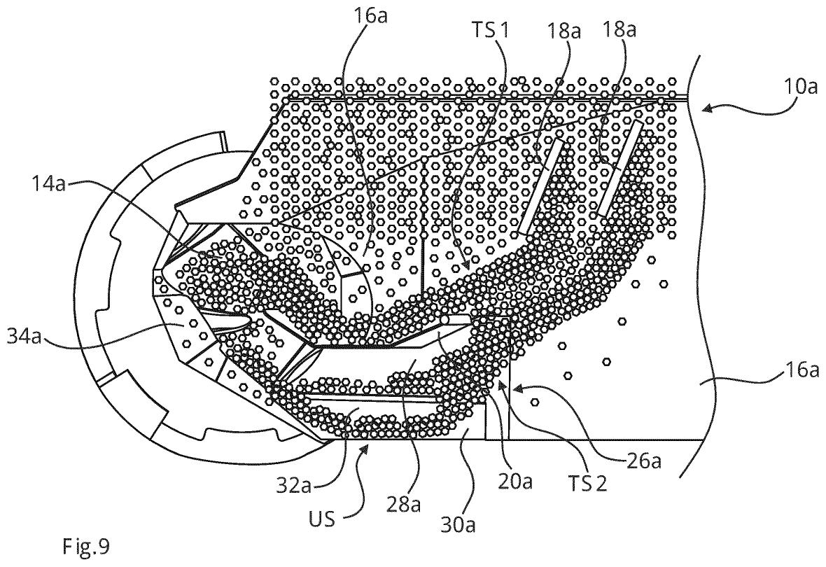

FIGS. 8 and 9 show that a spillover flow US from second partial flow TS2 forms in the region of spillover saddle 30a. Spillover flow US forms when a flow spillover height of spreadable material S in the region of spillover saddle 30a is exceeded. The flow spillover height corresponds to the saddle height of spillover saddle 30a Spreadable material S moving below the flow spillover height does not reach spillover path UEP of spillover saddle 30a. Spreadable material S moving above the flow spillover height reaches spillover path UEP of spillover saddle 30a.

A portion of spillover flow US continues to flow around chute opening 14a and reaches guide surface 34a which is arranged on the side of chute opening 14a that is disposed opposite supply region 12a. Due to the resulting partial flows TS1, TS2, US of spreadable material, which move along paths SGP1, SGP2, UEP, UMP for spreadable material, it is possible for actuator 104a to be loaded without any quantity effects.

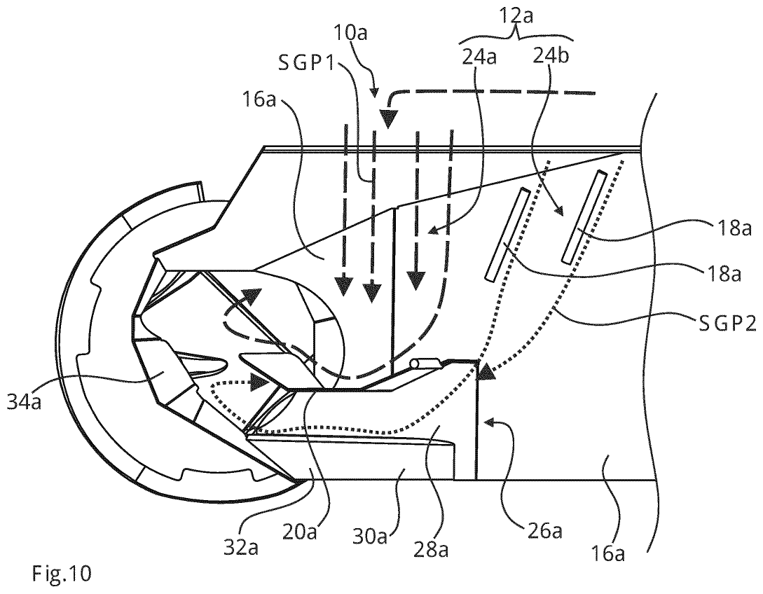

FIG. 10 shows paths SGP1, SGP2 for spreadable material along which spreadable material S moves when the amount of spreadable material S supplied is comparatively small.

Separating body 20a is arranged such that a partial flow TS1 of spreadable material following path SP1 for spreadable material and a partial flow TS2 of spreadable material following path SGP2 for spreadable material arise independently of the amount of spreadable material supplied onto supply region 12a. However, the amount of spreadable material in partial flow TS2 of spreadable material flowing along path SGP2 for spreadable material is not sufficient for a spillover at spillover saddle 30a when a small amount of spreadable material S is supplied. As a result, no spreadable material S reaches guide surface 32a on spillover saddle 30a. Partial flow TS2 of spreadable material following path SGP2 for spreadable material is therefore not divided again on chute ramp 26a.

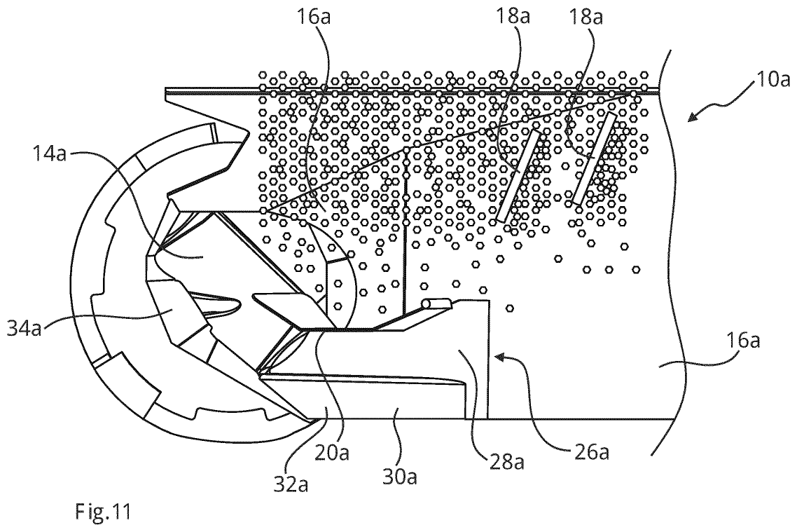

FIGS. 11 to 13 show the development of partial flows TS1, TS2 of spreadable material on chute 10a for spreadable material.

FIG. 11 shows that a portion of supplied spreadable material S is deflected by guide elements 18a in the direction of chute 26a for spreadable material.

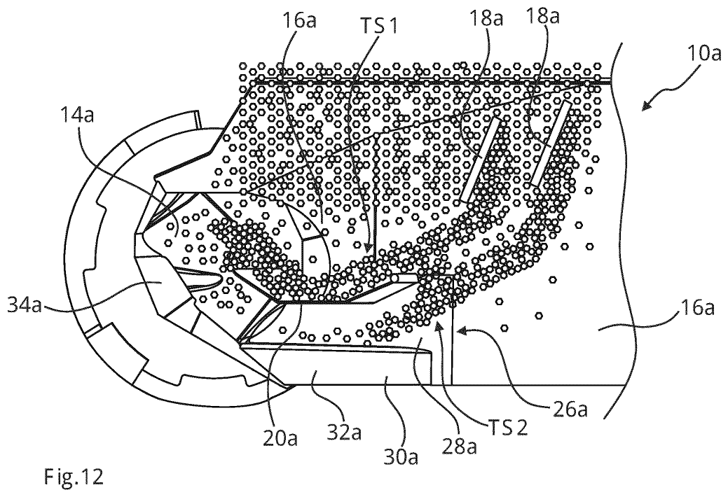

As is evident from FIG. 12, partial flows TS1, TS2 of spreadable material, which are delimited from one another by separating body 20a, are formed even when a comparatively small amount of spreadable material S is supplied.

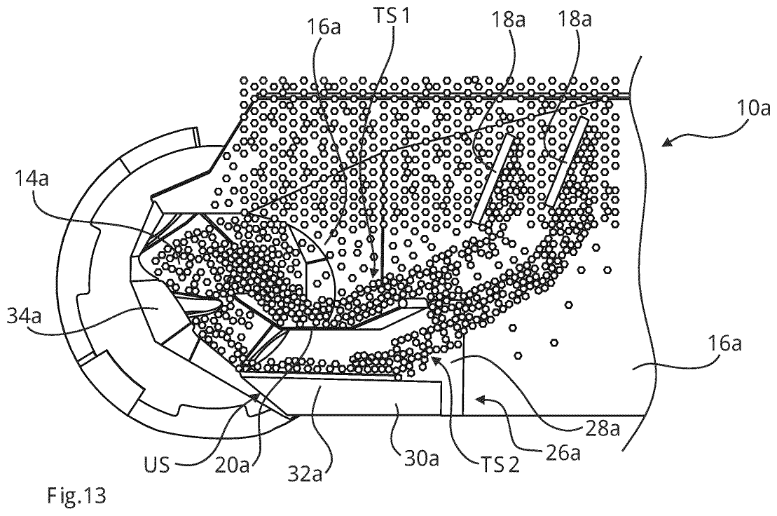

As FIG. 13 shows, with the depicted amount of spreadable material S supplied, a small partial flow of spreadable material forms which follows spillover path UEP on the spillover saddle.

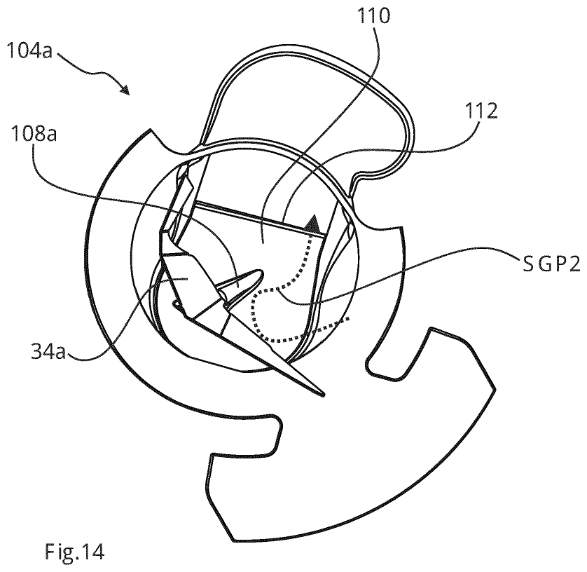

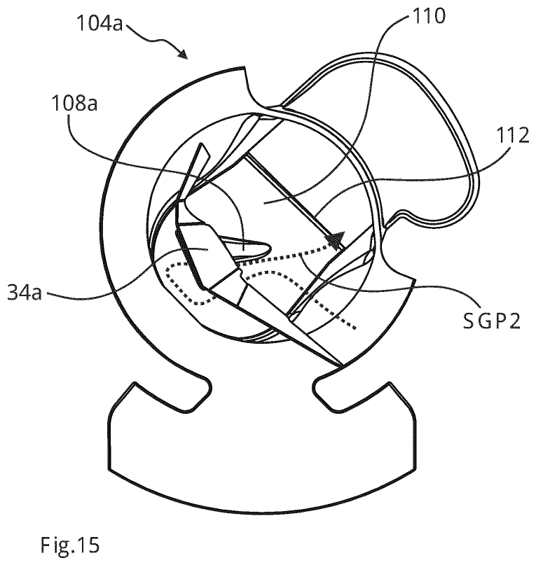

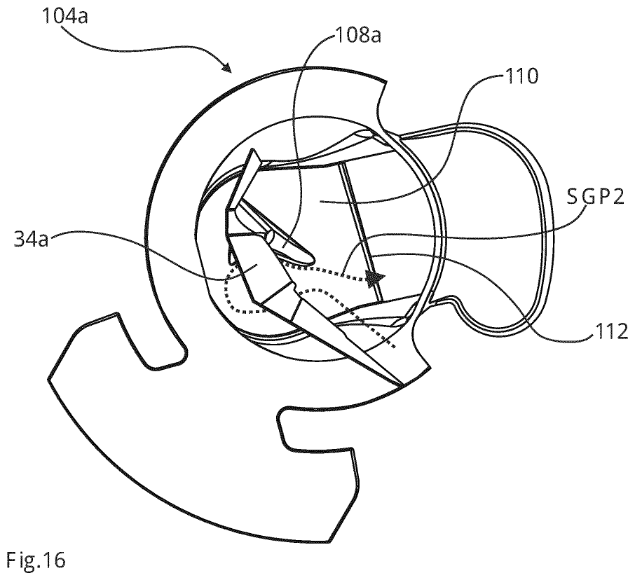

FIGS. 14 to 16 show that actuator 104a comprises a downwardly inclined discharge surface 110 with a discharge edge 112. Spreadable material S leaving discharge surface 110 via discharge edge 112 drops onto spreading disk 106a due to gravity. By rotating actuator 104a, the orientation of discharge surface 110 and its discharge edge 112 relative to spreading disk 106a can be changed so that the point of discharge and the direction of discharge of spreadable material S in the direction of spreading disk 106a and therefore also the point of impact of spreadable material S onto spreading disk 106a is adjustable by way of a rotation of actuator 104a.

FIGS. 14 to 16 show different positions of the angle of rotation of actuator 104a. The figures also show that a nose 108a on discharge surface 110 of actuator 104a ensures, regardless of the angular position of actuator 104a, that spreadable material S is discharged in a concentrated manner at the lateral edge of discharge surface 110 of actuator 104a over discharge edge 112 in the direction of spreading disk 106a. In this way, even small quantities of spreadable material have the necessary spread to implement the desired spreading pattern without any quantity effects.

### LIST OF REFERENCE CHARACTERS

10a, 10b chutes for spreadable material
12a, 12b supply regions
14a, 14b chute opening
16a, 16b guide surfaces
18a, 18b guide elements
20a, 20b separating bodies
22a, 22b contact bevels
24a, 24b partial sections
26a chute ramp
28a guide surface
30a spillover saddle
32a guide surface
34a guide surface
100 supply system
102 conveying device
104a, 104b actuators
106a, 106b spreading disks
108a nose
110 discharge surface
112 discharge edge
S spreadable material
SGP1, SGP2 paths for spreadable material
TS1, TS2 partial flows of spreadable material
UEP spillover path
UMP circulation path
US spillover flow

1. A chute for spreadable material for guiding spreadable material in the direction of a spreading disk of a spreader,
several guide surfaces which extend from a supply region for said spreadable material in the direction of said spreading disk;
a separating body which separates a first path for spreadable material from a second path for spreadable material so that said spreadable material supplied onto at least one of said guide surfaces in said supply region is divided at least temporarily during the motion in the direction of said spreading disk into a first partial flow of spreadable material which moves along said first path for spreadable material, and a second partial flow of spreadable material which is delimited from said first partial flow of spreadable material by said separating body and moves along said second path for spreadable material.

2. The chute for spreadable material according to claim 1,
wherein said separating body is arranged such that said first partial flow of spreadable material and said second partial flow of spreadable material delimited from said first partial flow of spreadable material arise independently of the amount of spreadable material supplied onto said supply region.

3. The chute for spreadable material according to claim 1, wherein said separating body is configured as a separating web which stands upright on a guide surface.

4. The chute for spreadable material according to claim 1, wherein one or more guide surfaces form a chute ramp, wherein said first path for spreadable material or said second path for spreadable material runs over said chute ramp.

5. The chute for spreadable material according to claim 1, further comprising a spillover saddle which is arranged in a spillover region at or on a guide surface and provides a spillover path for said spreadable material on which a spillover flow of spreadable material forming from said first or said second partial flow of spreadable material can be guided in the direction of said spreading disk.

6. The chute for spreadable material according to claim 5, wherein said spillover saddle is disposed on said chute ramp.

7. The chute for spreadable material according to claim 1, wherein said guide surfaces are configured to guide said spreadable material to a chute opening of said chute for spreadable material via which said spreadable material leaves said chute for spreadable material in the direction of said spreading disk, wherein said region (12a, 12b) where said spreadable material is supplied to said chute for spreadable material is disposed on a first side of said chute opening and at least one circulation path (UMP) of said spreadable material leads to a guide surface which is disposed on a second side of said chute opening.

8. The chute for spreadable material according to claim 7, wherein said circulation path is part of said spillover path, or said spillover path merges into said circulation path.

9. The chute for spreadable material according to claim 7, further comprising a contact bevel which is configured to prevent spreadable material supplied onto said chute for spreadable material from dropping through said chute opening without contact with a guide surface.

10. The chute for spreadable material according to claim 1, further comprising one or more guide elements arranged on at least one of said guide surfaces and configured to deflect said spreadable material flowing along said guide surface.

11. The chute for spreadable material according to claim 10, wherein said guide elements extend along a longitudinal axis and said longitudinal axes extend substantially in the direction of said path for spreadable material leading to said chute ramp.

12. A supply system for spreadable material comprising:
a chute for spreadable material with a chute opening via which spreadable material supplied onto said chute for spreadable material leaves said chute for spreadable material in the direction of a spreading disk; and
an actuator that is movable relative to said chute for spreadable material below said chute for spreadable material, wherein the point of discharge and/or the direction of discharge of said spreadable material in the direction of said spreading disk are adjustable with a motion of said actuator wherein said chute for spreadable material is configured according to claim 1.

13. The supply system according to claim 12, wherein said actuator is configured as a rotatable and/or slideable funnel tip.

14. A spreader for spreading spreadable material(S) comprising;
a storage container for spreadable material;
at least one spreading disk that can be driven in rotation;
a chute for spreadable material for guiding spreadable material in the direction of said spreading disk; and
a conveying device for conveying spreadable material onto said chute for spreadable material;
wherein said chute for spreadable material is configured according to claim 1.

15. A spreader for spreading spreadable material, comprising:
a storage container for spreadable material;
at least one spreading disk that can be driven in rotation;
a chute for spreadable material for guiding spreadable material in the direction of said spreading disk; and
a conveying device for conveying spreadable material onto said chute for spreadable material;
wherein said chute for spreadable material is part of the supply system according to claim 12.
